(19) United States
(12) Patent Application Publication
(10) Pub. No.: US 2003/0105807 A1
(43) Pub. Date: Jun. 5, 2003

(54) URL munging

(75) Inventors: Mark R. Thompson, Chandler, AZ (US); Nathan F. Raciborski, Jackson, WY (US); Mohan I. Kokal, Peoria, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aerocast.com, Inc., San Diego, CA (US)

(21) Appl. No.: 10/007,420

(22) Filed: Nov. 30, 2001

(51) Int. Cl. G06F 15/16

(52) U.S. Cl. 709/203; 709/247

(57) ABSTRACT

According to the invention, a method for encapsulating information in an encoded uniform resource identifier (URI) having a plurality of fields that is presented by a web site to a user for selection during an interaction session between the web site and the user is disclosed. In one step, a URI field is chosen for encapsulating the information. First information is determined that comprises at least one of second information and third information. The third information is unrelated to the interaction session. Fifth information related to the first information is formatted to create sixth information. Sixth information is embedded in the field to form the encoded URI. The encoded URI is presented to the user.

### BACKGROUND OF THE INVENTION

This invention relates in general to networked computer systems and, more specifically, to network data transfer.

A uniform resource identifier (URI) is used to specify the location of an object, such as a web page, on a network. The URI for a web page, for example, includes an access scheme, a hostname, a path, and a file name. While browsing web pages, the URI may include information relating to a user and their interaction with that web site. For example, an account number or other variables may be embedded into the URI to allow passing data between web pages and sites without using a cookie.

Servers on a network communicate by sending information back-and-forth between themselves. Two protocols used to communicate information are file transport protocol (FTP) and secure copy (SCP). For example, a computer associated with a user may download an application using FTP. A URI may be used to specify a location of a file for download using FTP, e.g., ftp://ftp.domain.info/path/file.txt.

### BRIEF DESCRIPTION OF THE DRAWINGS

The present invention is described in conjunction with the appended figures:

FIG. 1 is a block diagram of an embodiment of a munged URI system;

FIG. 2A is a block diagram of an embodiment of an URI encoder;

FIG. 2B is a block diagram of an embodiment of an URI decoder;

FIG. 3A is a diagram of a URI munge example;

FIG. 3B is a diagram of another URI munge example;

FIG. 4A is a flow diagram of an embodiment of a process for encoding a munged URI;

FIG. 4B is a flow diagram of another embodiment of the process for encoding a munged URI;

FIG. 5A is a flow diagram of an embodiment of a process for decoding the munged URI; and

FIG. 5B is a flow diagram of another embodiment of the process for decoding the munged URI.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

The present invention provides a mechanism for transferring data between web sites using a uniform resource locator. The data may or may not have anything to do with the user who transports the data. Data embedded in the URI can be compressed and/or encrypted. Some embodiments include lifetime and identification information in the URI to allow for authorization checks before allowing access to the object specified by the URI.

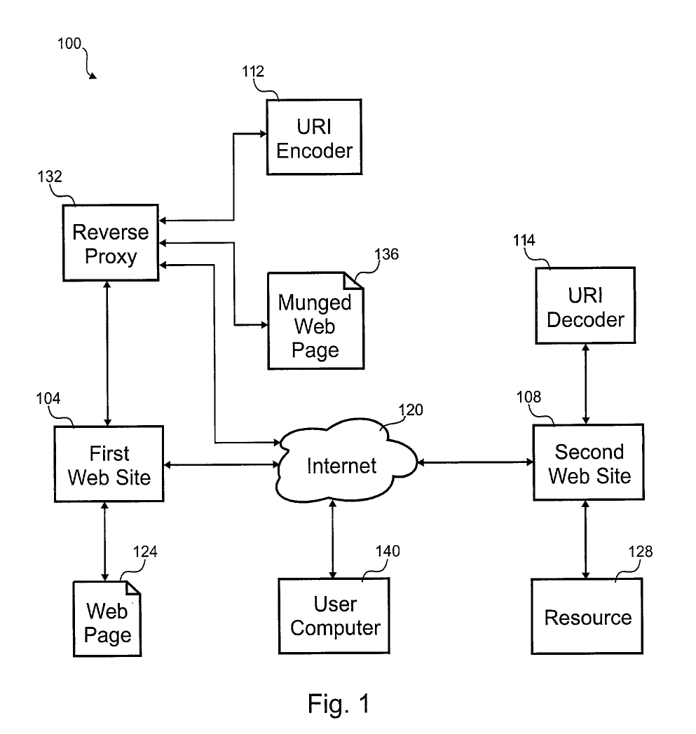

Referring to FIG. 1, a block diagram of an embodiment of a munged URI system 100 is shown. Generally, a user browsing a first web site 104 is provided a munged URI that is passed by the user's browser to a second web site 108 where it is decoded. A resource 128 specified by the URI is accessed at the second web site 108. Information is passed from the first web site 104 to the second web site 108 in the munged URI. Also included in the munged URI system 100 are a user computer 140, a reverse proxy 132, a URI encoder 112, a URI decoder 114, a web page 124, and a munged web page 136. The first and second web sites 104, 108, the reverse proxy 132, and the user computer 140 are networked together with the Internet 120 or some other wide area network. A local area network (LAN) may be used to connect the first web site 104, reverse proxy 132 and URI encoder 112 together and another LAN to connect the second web site 108 with the URI decoder 114.

The user accesses the system 100 with a user computer 140. On the user computer 140 is browser and other software that uses URIs to identify resources on the Internet 120. The user computer 140 is connected to the Internet with a modem of some sort. The user logs onto the first web site 104 looking for resources embedded in a web page 124. The reverse proxy 132 intercepts the request for the web page 124 and provides the munged web page 136 instead.

The reverse proxy 132 requests the web page 124 itself and rewrites all the URIs in the web page 124 using the URI encoder 112. Once rewritten, the munged URIs are substituted for the original URIs and presented to the user in a munged web page 136. From the user's perspective, the munged web page 136 appears identical to web page 124, but all of the links now include additional information provided through the munging process as described further below.

Each URI in the web page 124 may point to a different destination web site, but for simplicity, only one destination web site is depicted, namely, the second web site 108. The second web site 108 provides the resource 128 indicated in the URI to the user. In some embodiments, the second web site 108 is a cacheing server. Further, second web site could be an edge server that caches a resource that originated from the first web site 104 or could be the originator of the resource 128.

When the second web site 108 receives a munged URI from the user computer 140, that munged URI is processed in the URI decoder 114 to determine the resource 128 being requested. Further, the URI decoder provides any additional information embedded in munged URI to the second web site 108.

The information embedded in the munged URI could be information relating to the user or an interaction session of the user with the first web site 104. In other cases, the information could have nothing to do with the user or the interaction session. For example, the first web site 104 may want to transport information to the second web site 108 and use the munged URI as the transport mechanism. The interaction session information is defined herein as information relating to the interaction between the first web site 104 and the user. For example, interaction session information could include information relating to a purchase if the user is purchasing something from the first web site 104.

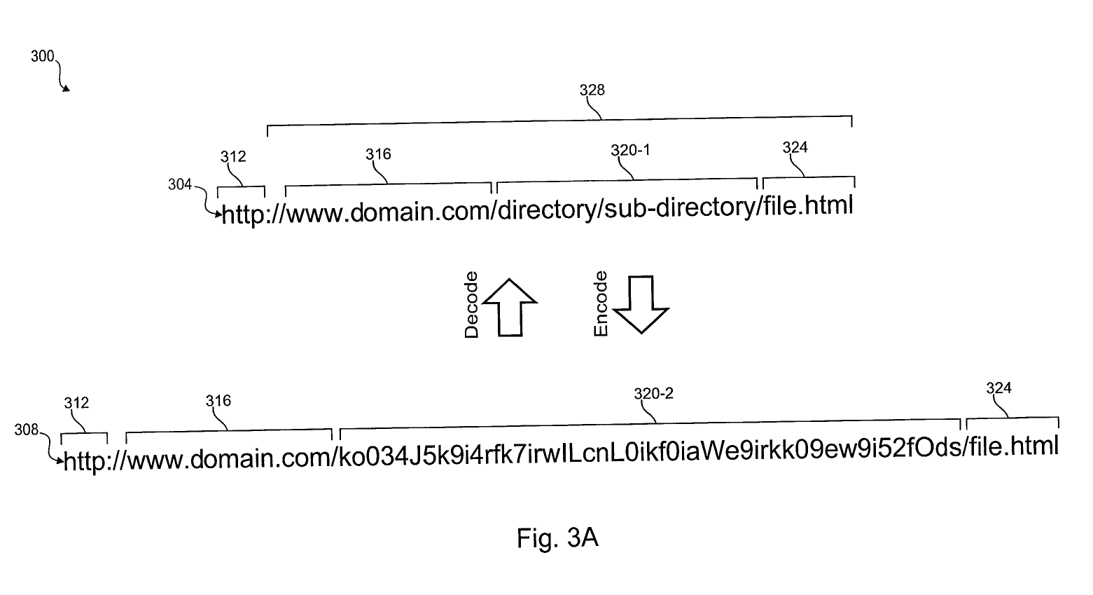

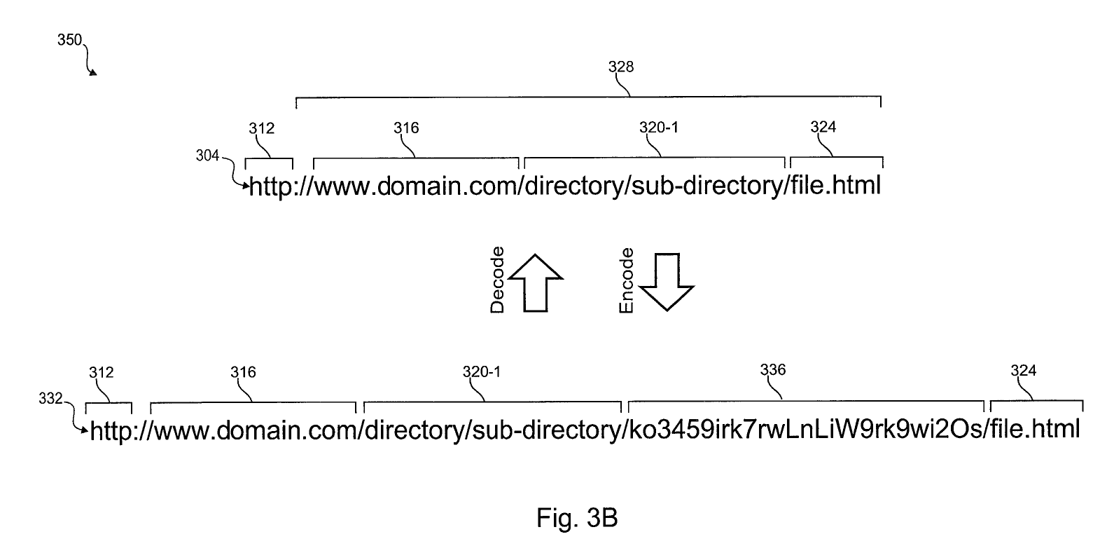

In the case where the second web site is a cacheing edge server, the information may include the original location for the resource 128, an expiration for the encoded URI after which the resource 128 should not be provided even if still cached, mirror sites for a resource 128 indicated by the munged URI, an identifier indicating the web site that built the munged URI, status information for the first web site 104, etc. Information relating to the user or the interaction session could include a user identifier, a user authorization password, an association for the user such as the ISP of the user, a credit amount for purchasing resources that is associated with the user, cost quoted for the resource 128 indicated by the munged URI, rights associated with the user for accessing resources from the second web site 108, any URI field that is replaced in the encoded URI as explained in relation to FIG. 3A below, etc.

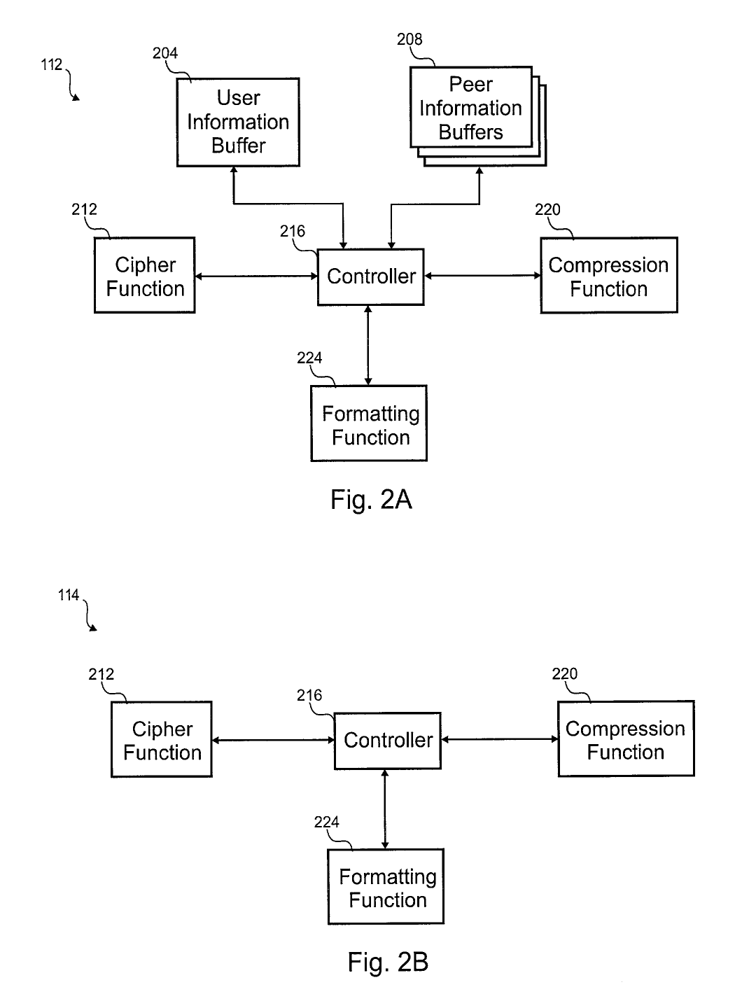

Referring to FIG. 2A, a block diagram of an embodiment of an URI encoder 112 is shown. The URI encoder 112 takes an URI and embeds other information to form a munged URI. The URI encoder includes a controller 216, user information buffers 204, peer information buffers 208, a cipher function 212, a compression function 220, and a formatting function 224. In some embodiments, the URI encoder 112 could be wholly or partially remote to the reverse proxy 132.

The information embedded into URIs is maintained in user information buffers 204 and peer information buffers 208. The user information relates to users or their interaction sessions, while the peer information relates to web sites 108 specified for providing resources 128. These buffers 204, 208 could be databases or other data structures. As the information for the buffers 204, 208 is determined, it is stored in the buffers 204, 208 such that a request to munge a URI can readily incorporate this information.

The controller 216 manages the munging process. The user and web site 108 for the resource 128 are determined and any information is gathered from the buffers 204, 208 relating to these parties. That information is embedded in an information data structure. The information data structure either incorporates a field from the URI or is added as a new field to the URI. That field is compressed, encrypted and formatted before insertion into the munged URI.

The compression function 220 may be software and/or hardware that provides lossless compression of the field of information. Possible algorithms for this lossless encryption include gzip (Lempel-Ziv LZ77) compression, zlib compression, run length encoding (RLE), and Huffman encoding, but other lossless algorithms could be used. Some embodiments could forgo the compression step entirely.

Encryption by the cipher function 212 can be done either before or after compression. Encryption can use simple code table approaches or more sophisticated private or public key techniques. In some embodiments, encryption may not be used.

Once the field is compressed and encrypted it may no longer be in a format compatible with URI schemes. A formatting function converts the field to a compatible format. One such formatting scheme is to convert the information to base-64. After formatting, the munged field is inserted into the munged URI. The reverse proxy substitutes the original URI with the munged URI in creation of the munged web page 136.

Referring to FIG. 2B, a block diagram of an embodiment of an URI decoder 114 is shown. The URI decoder 114 undoes the processing performed by the URI encoder 112 to recreate the embedded information and original URI. Each of the compression function 220, the cipher function 212, and the formatting function 224 perform the converse process as described above in relation to FIG. 2A to losslessly recreate the information and URI under the management of the controller 216. The resource 128 specified by the URI is provided to the user and the information is processed by the second web site 108.

With reference to FIG. 3A, a diagram of a URI munge example 300 is shown. In the figure, an original URI 304 is interchangeable with a munged URI 308 through a decoding/encoding. The URIs in this embodiment use a http scheme 312, but other embodiments could use any URI scheme. Each scheme has a scheme-specific portion 328 whose syntax is defined by the scheme protocol. For the http scheme 312, the scheme-specific portion 328 includes three fields, namely, a hostname field 316, a path field 320 and a file field 324. The hostname field corresponds to an IP address for the second web site 108 obtainable through a domain name server (DNS) lookup process. The file field 324 corresponds to a file that stores the resource 128.

The path field 320 holds the munged field for this embodiment. Under the normal http scheme, the path field 320 describes where on the second web site 108 the file is stored. With the munged http scheme, the path field 320-1 is replaced with a munged field 320-2. In the munged field, the path field 320-1 is encoded along with the other information transported in the URI.

Referring to FIG. 3B, a diagram of another URI munge example 350 is shown. In this munged http scheme, the path field 320-1 remains intact in the munged URI. The embedded information is added to a new munge field 336 in the munged URI. The examples of FIGS. 3A and 3B, are not meant to be an exhaustive list of how munged information can be embedded in a URI. Other embodiments could use any URI scheme and other field that didn't interrupt normal processing of the URI. For example, the “www” domain sub-field, the file name or file extension fields, the scheme field could be used for a http scheme, but the hostname should not be used for incorporation of munge information as the second web site 108 may not be found if the domain is changed.

Some embodiments of the system 100 could accept both munged and original URIs at the second web site 108. A field in the munged URI could indicate that a URI is munged such that the field is checked before attempting to decode the URI. Other embodiments could try to unmunge a URI after an attempt to process it as an original URI reports an error.

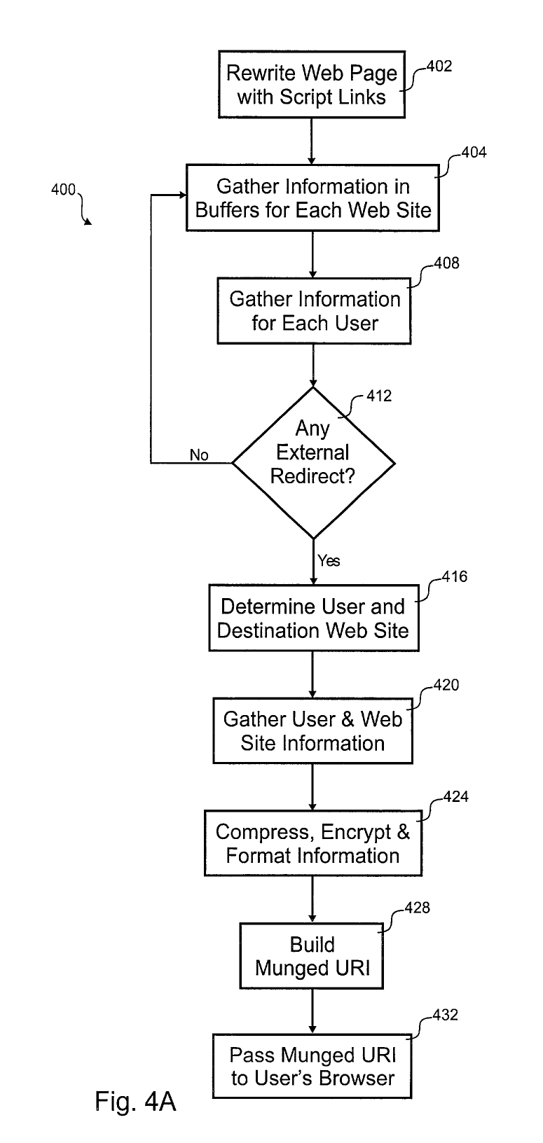

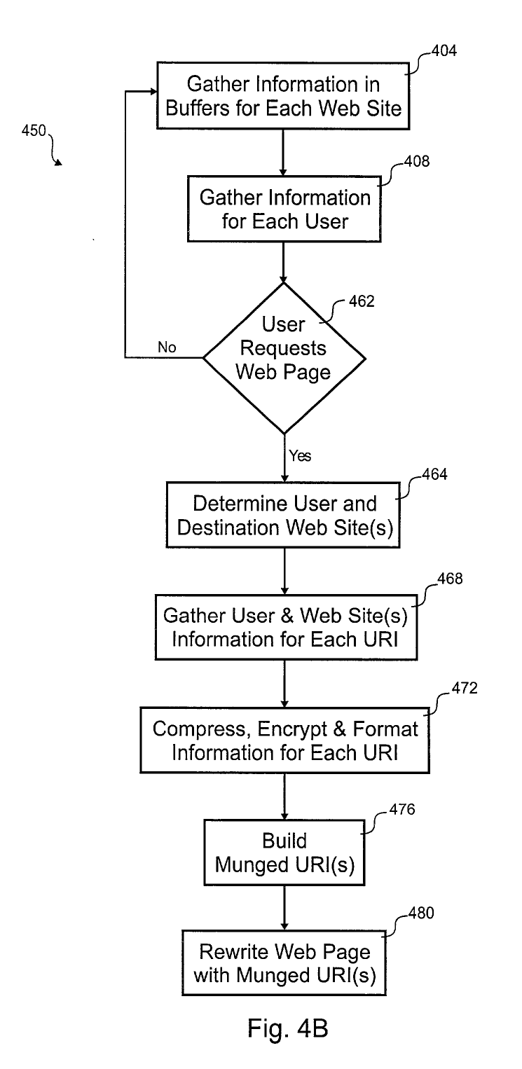

Referring to FIG. 4A, a flow diagram of an embodiment of a process 400 for encoding a munged URI 308 is shown. This embodiment rewrites the munged web page 136 to include a script for each URI from the original web page 124. Clicking on the script causes the latest information from the buffers to be embedded in a munged URI 308 that the user's browser is redirected with. This technique allows determining the URI the user uses to exit the first web site 104. The depicted portion of the process begins in step 402 where the all the original URIs 304 in the web page 124 are replaced with script links.

In a loop, information is gathered for the buffers 204, 208 in preparation for a request for that information to embed it into a munged URI 308. In step 404, information is gathered in the peer information buffers 208. In step 408, information is gathered for each user of the web site 104. Generally, the user and peer information is gathered in the normal course of operation of the web site 104. For example, every minute a web site loading calculation could be done, whereupon, that measurement is loaded into the peer information buffer 208 for possible inclusion in the next munged URI 308. In another example, the user name and password may be gathered from the user when they log into the first web site 104 and is stored in the user information buffer 204 at that time. If there is no script link selected in step 412, data gathering continues in steps 404 and 408.

Alternatively, processing continues to step 416 if a script link is selected. Clicking the script triggers a process where the user and destination web site are determined by the controller 216 in step 416. A code in the script link indicates the original URI 304 and the user for the rewritten web page. In step 420, the user and web site information is gathered from the buffers 204, 208. This information is compressed, encrypted and formatted in step 424. The munged URI 308 is built in step 428. The munged URI is passed to the user's browser in step 432 such that the browser is redirected to the target web site 108.

With reference to FIG. 4B, a flow diagram of another embodiment of process 450 for encoding a munged URI 308 is shown. This embodiment munges all the URIs in each web page 124 to present a munged web page 136 to the user. The munge information can include an expiration time for the URIs 308 in the munged web page 136. The depicted portion 450 of the process begins in step 404 where information for the target web sites 108 is gathered and stored in the peer information buffers 208. The user information is gathered and stored in step 408.

In step 454, processing loops back to step 404 if there is no request for a web page 124. Where there is a request for a web page, processing continues to step 464 where the user requesting the web page 124 and the target web sites 108 for the URIs 304 on the web page 124 are identified. In step 468, the user information and web site(s) information is gathered from the buffers 204, 208. This information may be combined with any field being replaced before compression, encryption and formatting in step 472. With information from the original URI(s) 304, the munged URI(s) 308 is built in step 476 for each URI 304 on the web page 124. The munged web page 136 is created with all the munged URIs 308 in step 480.

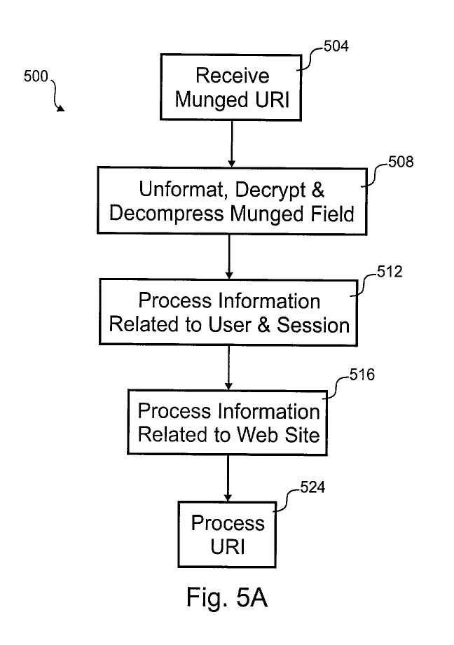

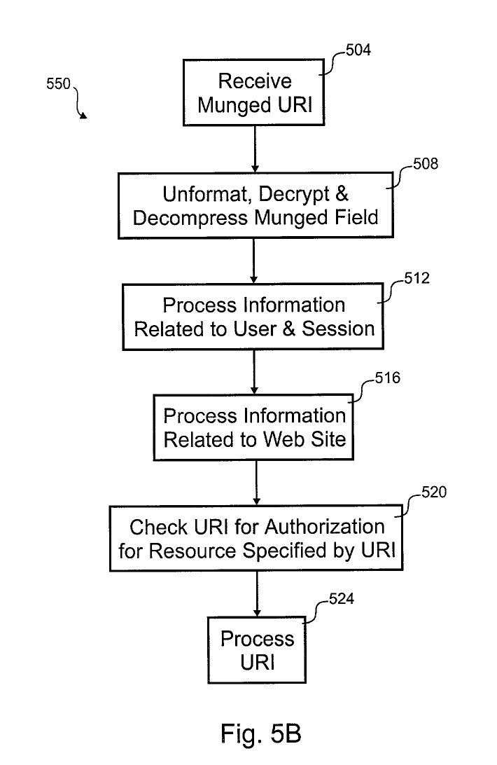

Referring to FIG. 5A, a flow diagram of an embodiment of a process 500 for decoding the munged URI 308 is shown. This embodiment decodes a munged URI 308 received from the user's browser to provide a resource 128 to the user and receive the un-munged information. The depicted portion of the process 500 begins in step 504 where the munged URI 308 is received in step 504. After unformatting, decrypting and decompressing the munged field 320-2, the original URI 304 is recreated along with embedded information in step 508. In step 512, the information on the user, the interaction session and the web site 104 is processed in steps 512 and 516. The resource 128 specified in the URI is provided to the user in step 524.

With reference to FIG. 5B, a flow diagram of another embodiment of a process 550 for decoding the munged URI 308 is shown. In contrast to the embodiment of FIG. 5A, this embodiment adds an authorization step 520 before allowing access to the resource 128. In step 520, the controller 216 checks the information to determine if access should be allowed. These checks could include one or more of the following: checking the expiration time for the URI, checking the user's identifier and password, checking for available credit for the user, checking that the referring web site 104 is authorized, etc.

While the principles of the invention have been described above in connection with specific apparatuses and methods, it is to be clearly understood that this description is made only by way of example and not as limitation on the scope of the invention.

What is claimed is:

1. A method for encapsulating information in an encoded uniform resource identifier (URI) having a plurality of fields that is presented by a web site to a user for selection during an interaction session between the web site and the user, the method comprising steps of:
choosing a URI field for encapsulating the information;
determining first information that comprises at least one of second information and third information, wherein the third information is unrelated to the interaction session;
formatting fifth information related to the first information to create sixth information;
embedding the sixth information in the field to form the encoded URI; and
presenting the encoded URI to the user.

2. The method for encapsulating information in the encoded URI having the plurality of fields that is presented by the web site to the user for selection during the interaction session between the web site and the user as recited in claim 1, further comprising steps of:
compressing the first information to create the third information; and
encrypting the third information to create the fourth information.

3. The method for encapsulating information in the encoded URI having the plurality of fields that is presented by the web site to the user for selection during the interaction session between the web site and the user as recited in claim 1, wherein a size of the encoded URI is limited to a range of about 4K to 8K characters.

4. The method for encapsulating information in the encoded URI having the plurality of fields that is presented by the web site to the user for selection during the interaction session between the web site and the user as recited in claim 1, wherein the formatting step comprises formatting fourth information in base 64 to create sixth information.

5. The method for encapsulating information in the encoded URI having the plurality of fields that is presented by the web site to the user for selection during the interaction session between the web site and the user as recited in claim 1, further comprising a step of encrypting third information related to the first information to create the fourth information, wherein the encrypting step uses at least one of: code table encryption, symmetric key encryption, and asymmetric key encryption.

6. The method for encapsulating information in the encoded URI having the plurality of fields that is presented by the web site to the user for selection during the interaction session between the web site and the user as recited in claim 1, further comprising a step of compressing the first information to create the third information, where the compressing step uses at least one of: gzip compression, zlib compression, run length encoding, and Huffman encoding.

7. The method for encapsulating information in the encoded URI having the plurality of fields that is presented by the web site to the user for selection during the interaction session between the web site and the user as recited in claim 1, wherein the third information is gathered by the web site for the benefit of another web site indicated by the encoded URI.

8. The method for encapsulating information in the encoded URI having the plurality of fields that is presented by the web site to the user for selection during the interaction session between the web site and the user as recited in claim 1, wherein the second information includes at least one of: a user identifier, a user authorization password, an association for the user, a credit amount associated with the user, cost quoted for a resource indicated by the encoded URI, rights associated with the user for content, the URI field if the URI field is replaced in the encoded URI.

9. The method for encapsulating information in the encoded URI having the plurality of fields that is presented by the web site to the user for selection during the interaction session between the web site and the user as recited in claim 1, wherein the third information includes at least one of: an expiration for the encoded URI, mirror sites for a resource indicated by the encoded URI, an identifier indicating the web site that built the encoded URI, and status information for the web site.

10. The method for encapsulating information in the encoded URI having the plurality of fields that is presented by the web site to the user for selection during the interaction session between the web site and the user as recited in claim 1, further comprising a step of analyzing the first information to determine if the encoded URI has expired.

11. A method for encapsulating information in an encoded uniform resource identifier (URI) having a plurality of fields that is presented by a web site to a user for selection during an interaction session between the web site and the user, the method comprising steps of:
choosing a URI field for encapsulating the information;
determining first information that comprises at least one of second information and third information;
compressing the first information to create the fourth information;
encrypting the fourth information to create the fifth information;
formatting fifth information to create sixth information;
embedding the sixth information in the field to form the encoded URI; and
presenting the encoded URI to the user.

12. The method for encapsulating information in the encoded URI having the plurality of fields that is presented by the web site to the user for selection during the interaction session between the web site and the user as recited in claim 11, wherein the third information is unrelated to the interaction session.

13. A method for decoding information in an encoded uniform resource identifier (URI) having a plurality of fields that is presented to a web site by a user where the encoded URI is produced during an interaction session between a referring web site and the user, the method comprising steps of:
determining a URI field that encapsulates sixth information;
removing the sixth information from the URI field; and
unformatting the sixth information to produce fifth information related to first information, wherein:
the first information comprises at least one of second and third information, and
the third information is unrelated to the interaction session.

14. A uniform resource identifier (URI) embodied in a carrier wave, comprising:
a scheme segment comprising a scheme for parsing the URI;
a scheme-specific segment comprising a payload portion and at least one of:
a host identifier,
path information, and
a file name, wherein the payload portion includes information that is at least one of formatted, compressed and encrypted.

15. The URI embodied in the carrier wave as recited in claim 14, wherein the information is both compressed and encrypted.

16. The URI embodied in the carrier wave as recited in claim 14, wherein the information is unrelated to an interaction session between a web site that built the URI and a user that selected the URI.

17. The URI embodied in the carrier wave as recited in claim 14, wherein the information is gathered by a web site that built the URI for the benefit of another web site indicated by the host identifier.

18. The URI embodied in the carrier wave as recited in claim 14, wherein the information includes user-related information.
